(19) United States
(12) Patent Application Publication
(10) Pub. No.: US 2009/0268229 A1
(43) Pub. Date: Oct. 29, 2009

(54) Multifunction Peripheral Browser Control for Application Integration

(76) Inventors: TANNA MARIE RICHARDSON, Happy Valley, OR (US); MARK LIU STEVENS, Laguna Hills, CA (US); JOEY PHILIP LUM, Irvine, CA (US)

Correspondence Address: MICHAEL BLAINE BROOKS, PC, P.O. BOX 1630, SIMI VALLEY, CA, 93062-1630, US

(21) Appl. No.: 12/107,926

(22) Filed: Apr. 23, 2008

(51) Int. Cl. G06K 15/00

(52) U.S. Cl. 358/1.15

(57) ABSTRACT

A multi-functional peripheral (MFP) browser having integrated scan, print, and/or e-mail functionality may be integrated within a system and support methods of scanning, printing and e-mailing via the MFP display.

### FIELD OF THE INVENTION

The embodiments of the present invention relate to multi-function peripherals, particularly to multi-function peripherals adapted to integrate scanning, emailing, and/or printing.

### BACKGROUND

Conventional multi-function peripherals (MFPs) offer basic scan and print functions that require users to perform multiple steps to complete a task. For example, if a user wanted to scan a resume and store that scanned document in a central database with metadata so that the scanned document may be searched by hiring managers, that user typically has to manually perform each step, i.e., scan the resume into a file, access such file containing the scanned resume using a personal computer, open a database application, load the file, and enter metadata for that file. Ways of integrating the various functions that may be performed by a user are thus highly desirable.

A client computing node of a network and/or a software application used in the client-server model where the server performs all, or nearly all, the processing may be termed a “thin client,” also known in the art as a “lean client.” Several network applications provide user interfaces through “thin clients,” where the network application includes a web server that can be accessed via standard web browsers (such as Microsoft™ Internet Explorer™ or Mozilla™ FireFox™) from a user's desktop. One example is document management applications that allow users to browse folders and open or add documents through a thin client interface.

Existing MFPs may provide HTML browsers. These HTML browsers may be used for display. Existing MFPs typically provide a pull print function that allows users at the MFP operation panel to browse an FTP server and select a file for printing. This provides print functionality that requires the files to be placed in a directory server, like FTP. Presently, there is a need for a browser having integrated scan, print, or e-mail functionality.

### SUMMARY

The present invention, as disclosed in apparatus, system and method embodiments provides new functionality for “thin client” applications as in a multi-function peripheral browser control for application integration. For example, a multi-functional peripheral may comprise: (1) an operation panel adapted to display at least one of: a print setting prompt, responsive to a print function tag; a scan setting prompt, responsive to a scan function tag; and an e-mail prompt, responsive to an e-mail function tag; (2) a browser adapted to drive a display of the operation panel and provide at least one of: the print function tag, the scan function tag and the e-mail function tag; and (3) at least one of: (a) a printer adapted to print a file and responsive to a user input via the operation panel; (b) a scanner adapted to scan a document and responsive to a user input via the operation panel; and (c) an e-mail module adapted to transmit an e-mail field and an attached file and responsive to a user input via the operation panel.

In some system embodiments of the present invention, the system may include: (1) a server and a multi-functional peripheral operably connected to the server via a network link, wherein the multi-functional peripheral comprises: (2) an operation panel adapted to display at least one of: a print setting prompt, responsive to a print function tag; a scan setting prompt, responsive to a scan function tag; and an e-mail prompt, responsive to an e-mail function tag; and (3) a browser adapted to drive a display of the operation panel and provide at least one of: the print function tag, the scan function tag and the e-mail function tag; and at least one of: (a) a printing module, responsive to a user input via the operation panel, adapted to retrieve a file from the server and print the file; (b) a scanning module, responsive to a user input via the operation panel, adapted to scan a document and generate a scanned document file and upload the scanned document file to the server; and (c) an e-mail module, responsive to a user input via the operation panel, adapted to attach the scanned document file to an e-mail transmission via the server.

In some method embodiments of the present invention, where one or more subprocesses may be executed within the execution of an overarching process, the method may include: (1) displaying, via an operation panel of an multi-functional peripheral (MFP) browser, at least one of: a print setting prompt when a print function tag is present; a scan setting prompt when a scan function tag is present; and an e-mail prompt when an e-mail function tag is present; and (2) responding as directed by a user input, via the operation panel of the MFP, by executing at least one subprocess selected from a group of subprocesses comprising: (a) a file printing subprocess comprising: retrieving a file from a server and printing the retrieved file; (b) a document scanning subprocess comprising: (i) scanning a document, (ii) generating a scanned document file and (iii) uploading the scanned document file to the server; and (c) a document scanning and e-mailing subprocess comprising: (i) addressing an e-mail, (ii) scanning a document, (iii) generating a scanned document file and (iv) attaching the scanned document file to the e-mail; (v) uploading the scanned document file to the server and (vi) generating an e-mail transmission via the server, the e-mail transmission having the scanned document file attached to the e-mail transmission.

### BRIEF DESCRIPTION OF THE DRAWINGS

The present invention is illustrated by way of example and not limitation in the figures of the accompanying drawings, and in which:

FIG. 1 is a high-level block diagram of an exemplary system according to an embodiment of the invention;

FIG. 2 is a functional block diagram of the various components of an exemplary system;

FIG. 3 is a flowchart of an exemplary print function of an embodiment of the present invention;

FIG. 4A is an exemplary user interface of an embodiment of the present invention;

FIG. 4B is an exemplary user interface of an embodiment of the present invention;

FIG. 4C is an exemplary user interface of an embodiment of the present invention;

FIG. 4D is an exemplary user interface of an embodiment of the present invention;

FIG. 5 is a flowchart illustrating an exemplary scanning process embodiment of the present invention;

FIG. 6A is an exemplary user interface page according to an embodiment of the present invention;

FIG. 6B is an exemplary user interface page according to an embodiment of the present invention;

FIG. 6C is an exemplary user interface page according to an embodiment of the present invention;

FIG. 6D is an exemplary user interface page according to an embodiment of the present invention;

FIG. 7 is a flowchart of an exemplary embodiment of the scanned e-mail process of the present invention;

FIG. 8A illustrates an exemplary interface page of an embodiment of the present invention;

FIG. 8B illustrates an exemplary interface page of an embodiment of the present invention;

FIG. 8C illustrates an exemplary interface page of an embodiment of the present invention; and

FIG. 8D illustrates an exemplary interface page of an embodiment of the present invention.

### DETAILED DESCRIPTION

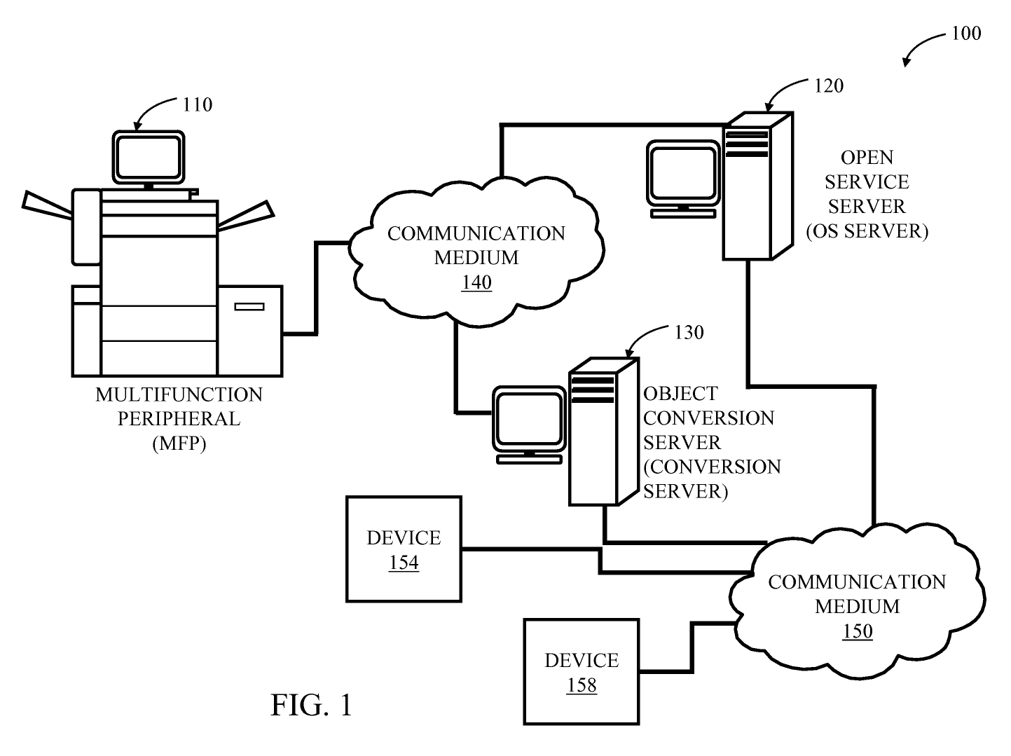

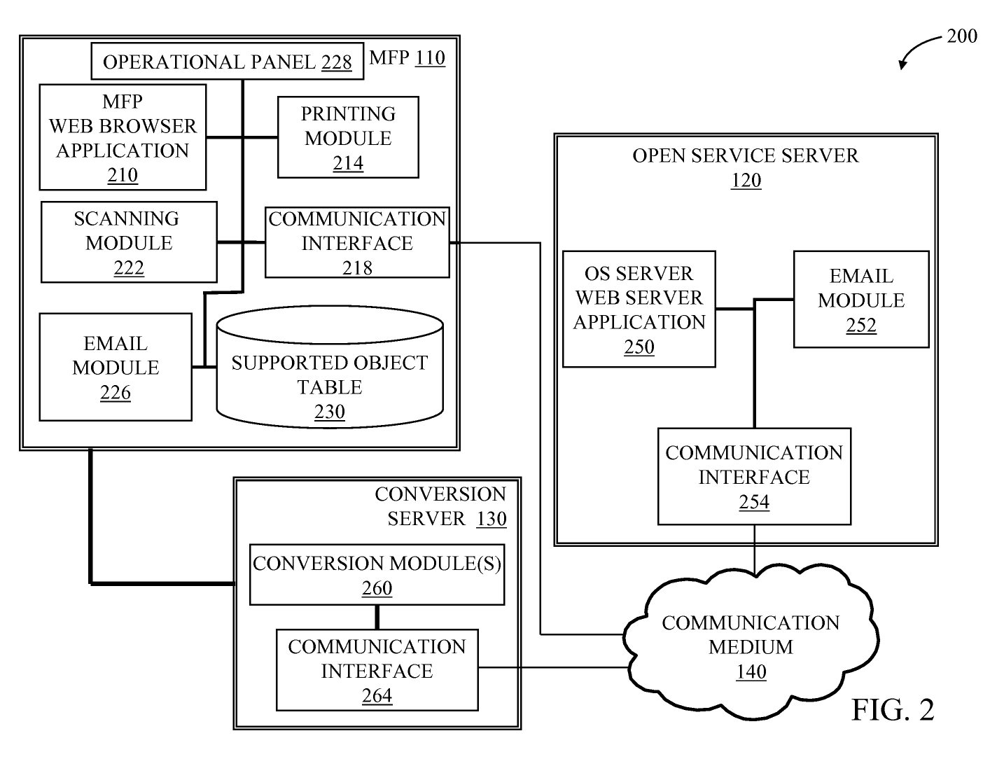

To better understand the figures, reference numerals within the one hundred series, for example, 110, 120, and 130, are initially introduced in FIG. 1, reference numerals in the two hundred series, for example, 210 and 250, are initially introduced in FIG. 2, and so on and so forth.

The embodiments of the present invention relate to multifunction peripherals. A multifunction peripheral (MFP) is typically a device that combines the function of multiple single-function peripherals. Conventional peripherals, such as scanners, facsimile machines, copiers, and/or printers, are typically stand-alone devices and/or coupled to a general-purpose computer, such as a personal computer (PC). The MFP of the present invention integrates various peripheral functions, which may include scanning, copying, and printing. Furthermore, the MFP of the present invention may also include an email module that enables a user, at the MFP, for example, to scan a document and accordingly transmit that scanned document via e-mail using the MFP, i.e., without using a PC, for example. Furthermore, in some embodiments, the MFP of the present invention is configured to interface with an object conversion server (OCS) that is configured to perform format conversions, so as to enable the MFP to print a document not supported as a native format of the MFP.

FIG. 1 is a high level block diagram 100 of an exemplary system, according to an embodiment of the invention. In this exemplary system, the multifunction peripheral (MFP) 110 may be operably coupled to a server, particularly an open service server 120 (OS Server) adapted to interface with the MFP 110, including provide web pages to the MFP. The OS Server may also provide an application service, e.g., a web application service. The system 100 may also include an object conversion server 130 (Conversion Server), or OCS, configured to convert objects, including files, from one file format to another. The MFP 110, the OS Server 120, and the Conversion Server 130 may be operably coupled to each other via a first communication network 140, such as a local area network or other types of network. In some embodiments, the Conversion Server 130 is part of the MFP 110 and/or part of the OS Server 120. In other embodiments, the OS Server 120 and/or the Conversion Server 130 are operably coupled to other devices 154, 158 via a second communication network 150, which may be a separate network or part of the first communication network 140, The devices 154, 158 may be peripherals, thin clients, and/or general purpose computers. The MFP 110, the OS Server 120, and/or the Conversion Server 130 may also be operably coupled to a wide area network, such as the Internet (not shown). Other variations in network configurations are expected and are within the scope of the present invention.

FIG. 2 is a functional block diagram of the various components of an exemplary system 200. In some embodiments, the MFP 110 may include several modules, such as an MFP web browser application 210, a printing module 214, a communication interface module 218, a scanning module 222, an email module 226, and a supported object table 230. The MFP 110 may include other modules, not shown, for example, a File Transfer Protocol (FTP) module, a Hypertext Transfer Protocol (HTTP) module, and other modules, which may depend on the other functions performed by the MFP 110.

The MFP web browser application module 210 may be embodied as a web browser application adapted to present user interfaces, presentations, or displays at a presentation device at the MFP. The MFP web browser module 210 is configured to enable a user to integrate scan, print, and/or email functions. Furthermore, the MFP web browser module 210 supports Hypertext Markup Language (HTML), thereby enabling users to view network applications, corporate websites, and/or Internet sites, via the MFP operation panel 228 in a fashion similar to a conventional web browser. The MFP web browser module may contain standard web-browser functions, such as providing Uniform Resource Locator (URL) entry, book-marking of saved URLs, navigation controls—e.g., previous, next, stop, and refresh, and a conventional print function. The conventional print function enables a user to print, via the conventional manner, the current page displayed by the web browser, which is different from the printing function performed by the printing module 214. The main window in the MFP browser displays the HTML pages associated with a specific URL. Users may type in a custom URL or select one from a saved list. Optionally, administrators may disable the ad hoc URL entry function and restrict access to an approved list of URLs available through, for example, the browser's “Saved” button. In addition to conventional web page display and printing, the MFP web browser 210 provides for file printing, file upload via scan, and email functions.

The printing module 214 is a module which is adapted to print objects processed by such exemplary MFP. The exemplary printing module may be configured to print objects, such as documents, retrieved as files or those that have been scanned. The scanning module 222 may be configured to perform the scanning operations of this MFP, which may include scanning documents or objects placed under the platen of the MFP, for example. The printing module 214 as mentioned above is different from the print function provided when a print menu option or a print button is typically selected in a conventional web browser. The email module 226 may be embodied as a client email application, e.g., a Simple Mail Transfer Protocol (SMTP) email client application. The email module 226 may be configured to enable a user at the MFP to send an email using the MFP. Such email may also include attachments such as files and/or objects scanned by the scanning module 222. Furthermore, the email module 226, if properly connected, may also transmit an email via the Internet. The supported object table 230 may include a list of objects supported by the MFP and its various modules. Such a table may include a list of supported Multipurpose Internet Mail Extensions (MIME) types and/or a list of printer drivers supported by the printing module. The communication interface 218 is configured to enable the MFP to connect and communicate with other devices, such as the OS Server and the Conversion Server, via a local area network, a wide area network, and/or the Internet, depending on network configuration.

The OS Server 120 may include an OS Server web server application 250 configured to enable the OS web server 250 to serve web pages to be presented by the MFP web browser 210. In some embodiments, the OS Server 120 may also include an email module 252, which may include an email client module and/or an email server module. The OS Server 120 may also include a communication interface 254 adapted to enable the OS Server 120 to communicate with the MFP and/or the Conversion Server 130.

The Conversion Server 130 may include one or more conversion modules 260 adapted to convert one object format to another. For example, a conversion module 260 may be configured so as to convert an object, such as a file in COREL® WORDPERFECT® format to another file format, such as the PORTABLE DOCUMENT FORMAT (PDF) that may be read by an ADOBE® reader. The Conversion Module 130 may also include a communication interface 264 configured to enable the Conversion Server 130 to communicate with the MFP 110 and/or the OS Server 120, via a network. In addition, the Conversion Server 130 may include one or more language conversion modules adapted to convert from one language to another, for example, a translation from English to Spanish languages.

The embodiments of the present invention allow users to direct paper input to and output from their existing applications and business processes typically with fewer steps than presently practiced. Embodiments of the present invention use an HTML browser hosted on an MFP, i.e., a thin client, to drive the display of the MFP operation panel in a fashion that integrates print, scan, and e-mail functions based on specific HTML actions or tags. The HTML browser, according to embodiments of the present invention, recognizes one or more of three tags in order to provide enhanced functionality. A first exemplary tag is a “URL to an application file” tag where, when recognized, causes the MFP to: prompt the user for print settings; retrieve the file from the server; and print the document. A second exemplary tag is a “form input of type=file” tag where, when recognized, causes the MFP to: prompt the user for scan settings; scan the document presented; and upload the scanned document to the server along with its representative form data. A third exemplary tag is a “‘mailto’ URL” tag where, when recognized, causes the MFP to prompt the user to: enter e-mail fields including addressing an attachment option. If the user selects attachments, the MFP prompts the user for scan settings, scans the document presented, and attaches the scanned document to the e-mail.

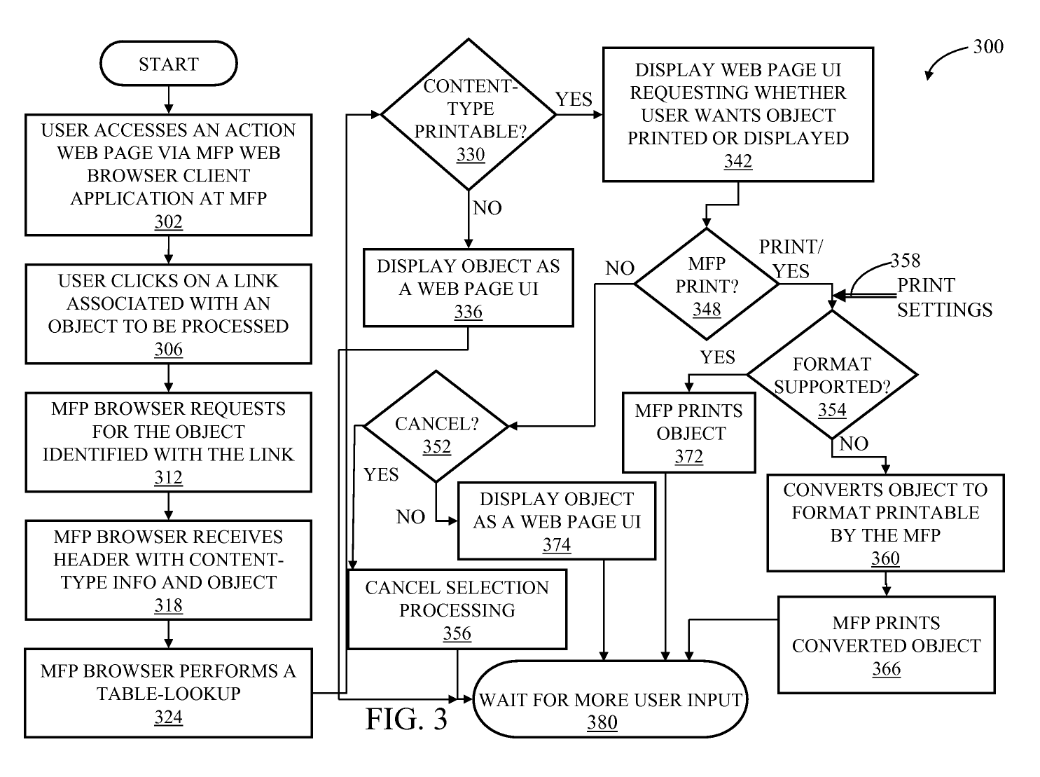

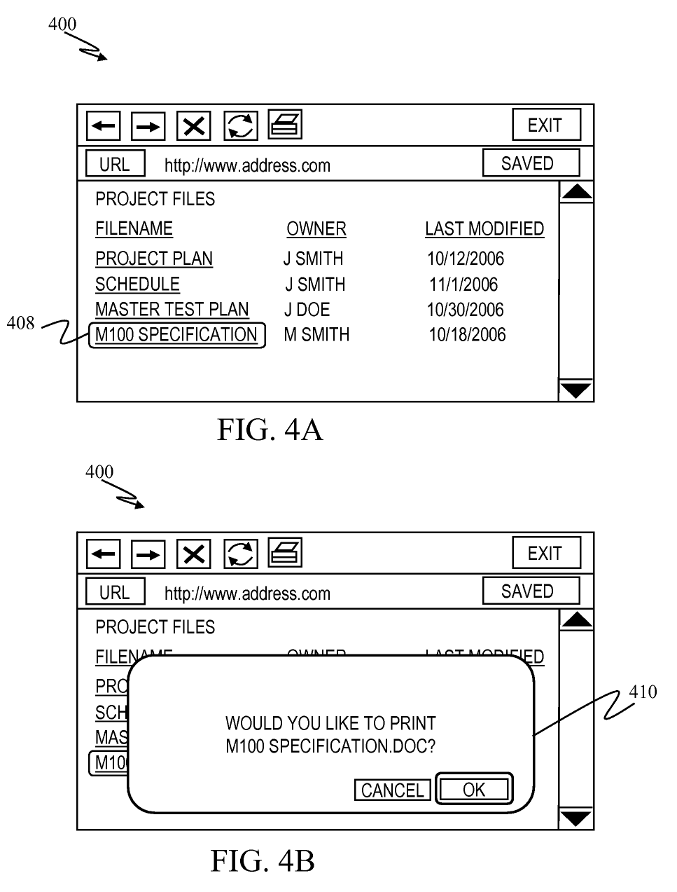

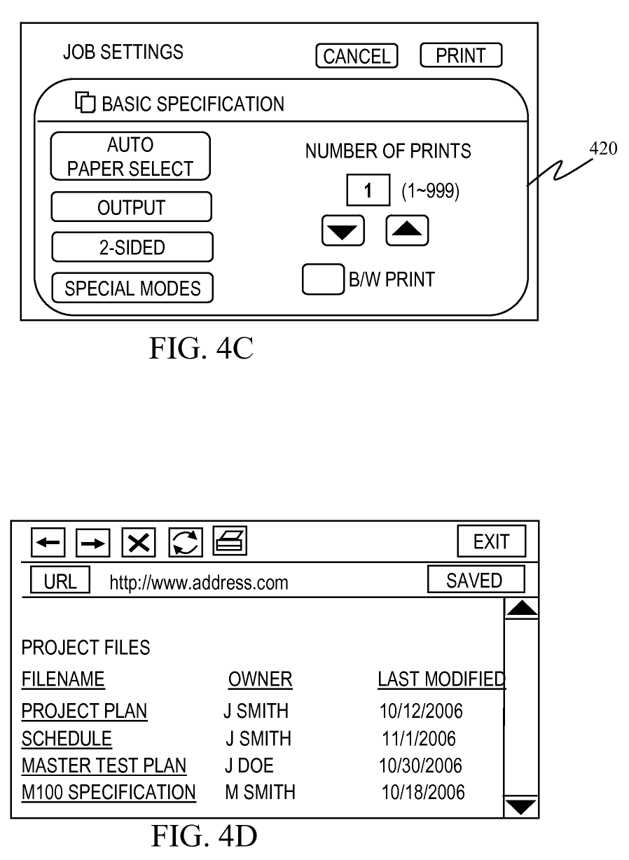

FIG. 3 is a flowchart of an exemplary print function of an embodiment of the present invention. FIGS. 4A, 4B, 4C, and 4D are user interfaces presented on the web browser application 210 on the operation panel of the MFP 110. FIGS. 3, and 4A-4D are generally discussed together.

Referring now to both FIG. 2 and FIG. 3, a user accesses an action web page via the MFP browser application module 210, using the operation panel 228 of the MFP (step 302). Examples of action web pages, which may be served by the OS web server application module 250, are shown in FIGS. 4A-4D. An example of an action web page displayed is the user interface (UI) 400 shown in FIG. 4A that may be part of the operation panel 228. The user may then click on a link associated with an object to be processed (step 306). In the example of FIG. 4A, the user may click on, or otherwise select, the “M100 Specification” link 408, which is associated with an M100 Specification file. The web browser application module 210, acting as the client, may then request, e.g., via HTTP, the object identified or associated with the link (step 312). The MFP browser 210 may then receive the requested object, as well as a header containing the content-type of the requested object (step 318). The MFP browser 210 may then perform a table lookup 324, e.g., mime-type table lookup, to determine whether the content type of the requested object is printable (step 330). Each URL object that is requested is typically received with a content-type variable that may indicate to the MFP browser the manner of handling of the object. For an example of a manner of handling an object, a content-type of “text/html” informs the browser that the browser may display the object as a web page. A content-type of “application/pdf” informs the browser to launch Adobe® Acrobat® to display the page rather than attempting to load the file directly in the browser.

Embodiments of the MFP browser of the present invention may use this content-type variable to determine whether to display or print a requested URL. The table lookup operation may indicate to the MFP browser whether such an object is printable, for example, based on mime type, file extension, and other means of file identification known in the art. If the content type of the object is not printable, e.g., the object may be a streaming video, then the object may be accordingly presented as a web page via the MFP web browser (step 336) and thereafter, there is a wait (step 380). In other embodiments, not shown, error messages may be displayed, if appropriate. If the content type of the object is printable, e.g., it is a PDF file, a MICROSOFT® WORD® document, or a web page, FIG. 4B, may be displayed asking a user if the user wishes to print the requested object. If the user cancels the operation, the object may be accordingly displayed (step 336) or the initial web page (FIG. 4A) may be activated and presented (which are steps not shown by the exemplary flowchart of FIG. 3). A web page user interface may be displayed requesting whether the user wants one or more objects printed or displayed (step 342), for example. If the MFP has been directed to print (test 348), print settings 358, including default or pre-set print settings or user revised print settings, may be used. As to the MFP browser checking whether the format of the object is natively supported (test 354) by the MFP 100 for printing (FIG. 2), this step may be also performed via table lookup operations. If the format of the object is natively supported by the MFP 100, the printing module 214 of the MFP 110 accordingly prints the requested object (step 372), using the print settings 358 indicated by the user. If the format of the object, however, is not natively supported (test 354) by the MFP, FIG. 3 illustrates by example that a conversion service such as the Conversion Server 130 (FIG. 1) may convert (step 360) the requested object to a format natively supported by the MFP and may thereafter print 366 the converted object. If the MFP has not been directed to print (test 348) and if the print is not cancelled (test 352), then the object is displayed via or as a webpage of the user interface (step 374). If the MFP has not been directed to print (test 348) and if the print is cancelled (test 352), then the selection process is cancelled (step 356) and thereafter, the process waits for further user input (step 380).

As shown in FIG. 4A, a user may select a hyperlink 408 on a displayed web page. When the browser retrieves the URL, the web browser checks the Content-Type and if it is a printable page, the MFP prompts the user if they would like to print the document, e.g., as shown in the pop-up window 410 of FIG. 4B. The MFP browser then displays a print setting dialog box 420 (FIG. 4C) and may optionally show a thumbnail preview of the document. The MFP 110, via the printing module 214 then prints the file. FIG. 4D shows, via the user interface, that the printed files may be presented in a listing.

The object to be converted may be accessed by the Conversion Server or may be transferred or copied to the Conversion Server 130. One of ordinary skill in the art will appreciate that the object to be converted may reside in various locations so long as the Conversion Server has access to the object to be converted. Similarly the object converted by the Conversion Server may reside in various locations so long as the converted object is accessible to the MFP printing module.

In some embodiments, the MFP web browser decides whether to display or print a requested object using a table of known content-types. For example, the MFP may display “text/html” and “text/xml” pages and it may be able to print “application/pdf,” “image/tiff,” “application/vnd.hp-PCL,” “application/postscript,” and “image/jpeg.” As part of the content-type validation process, an MFP categorizes the content-types into various category types, such as display, print, display and print, or unknown. In some embodiments, display and print types may be displayed on the operation panel and sent directly to the printing engine, respectively. Unknown files may generate an error or in a preferred embodiment, are sent to the Conversion Server 130 for translation or conversion, if possible, into a supported MFP format. The conversion service may be resident on the MFP or in an external server and may be responsible for translating the unknown file (e.g. “application/msword”) into a format that may be printed by the MFP. In some embodiments, after conversion, the converted object/file is returned to the MFP and printed. If the conversion service also does not recognize the content-type, an error is returned to the MFP and the MFP then displays an error message to the user. This conversion system may transfer the actual file to the MFP that is then forwarded to the external service, or it may transfer just the URL. In the exemplary case of a URL, the conversion service may retrieve the file from the application, convert it, and then send it to the MFP. This exemplary embodiment minimizes the number of times the complete file is sent across the network.

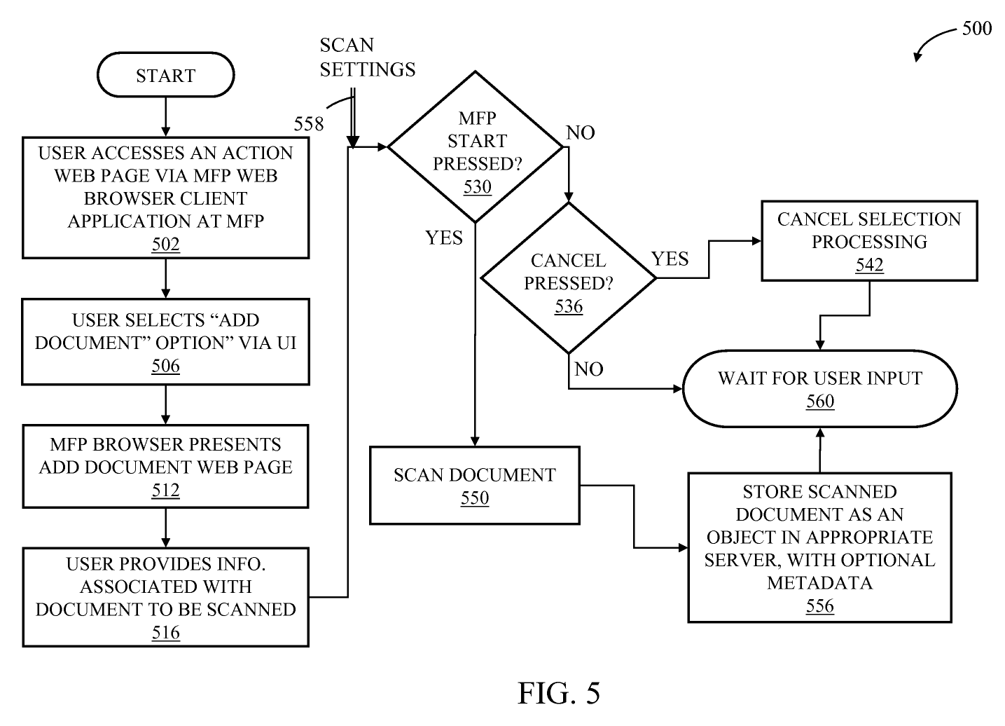

FIG. 5 is a flowchart illustrating an exemplary scanning process embodiment of the present invention. In this example, the user accesses an action web page via the MFP web browser client application hosted by the MFP (step 502). The user may select, for example, an “add document” option via the user interface of the MFP (step 506). The MFP browser presents the “add document” web page (step 512). Additional user-provided information may be entered and associated with the document to be scanned (step 516). Scan settings 558 may be default or pre-set settings or revised by the user prior to initiating (test 530) the document scanning (step 550). The scanning process may be cancelled (step 542) if the MPF cancel button is pressed (test 536). After scanning, the document is saved with optional metadata (step 556) in a store accessible via a server. Thereafter, the scanning process waits for further user input (step 560).

### File Upload Via Scan

A form tag may be used to prompt a user to upload or attach a file. The HTML below shows the form tag used to indicate (e.g., at <input type=“file” name=“file”>) that a file is expected:

```
<html>
  <head>
    <title>Sample</title>
    <meta http-equiv=“Content-Type” content=“text/html;
    charset=iso-8859-1”>
  </head>
  <body>
    <p>ADD DOCUMENT</p>
    <form name=“form1” method=“post” action=“add_doc.html”
                      enctype=“multipart/form-data”>
      <p>Title:
        <input type=“text” name=“textfield”>
      </p>
      <p>Owner:
        <input type=“text” name=“textfield2”>
      </p>
      <p>Source File:
        <input type=“file” name=“file”>
      </p>
      <p>
        <input type=“submit” name=“Submit” value=“Add Document”>
      </p>
    </form>
  </body>
</html>
```

A conventional browser, such as Windows™ Internet Explorer™, recognizes the type=file input and accordingly provides the user with a dialog box within which to select a file. Embodiments of the present invention have an MFP browser that recognizes the type=file input and, when recognition is made, prompts the user to scan a document for upload.

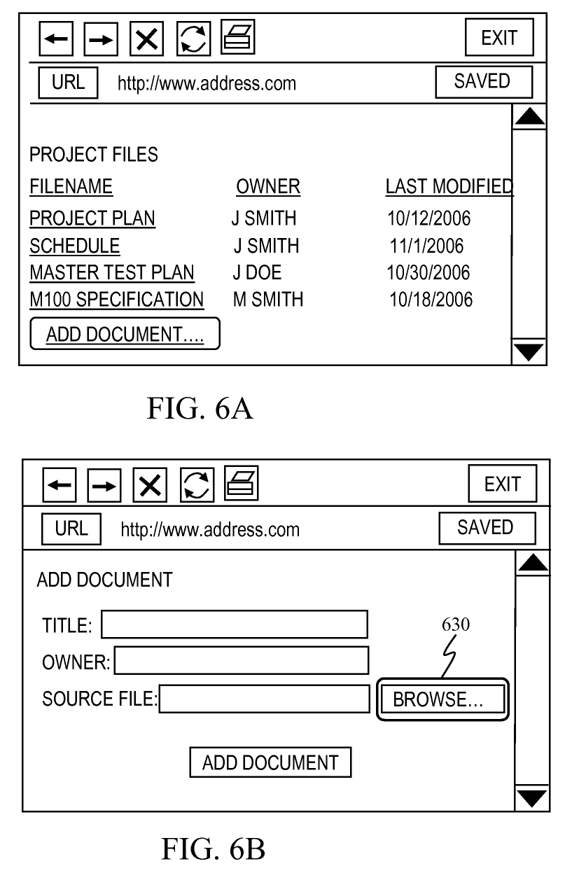

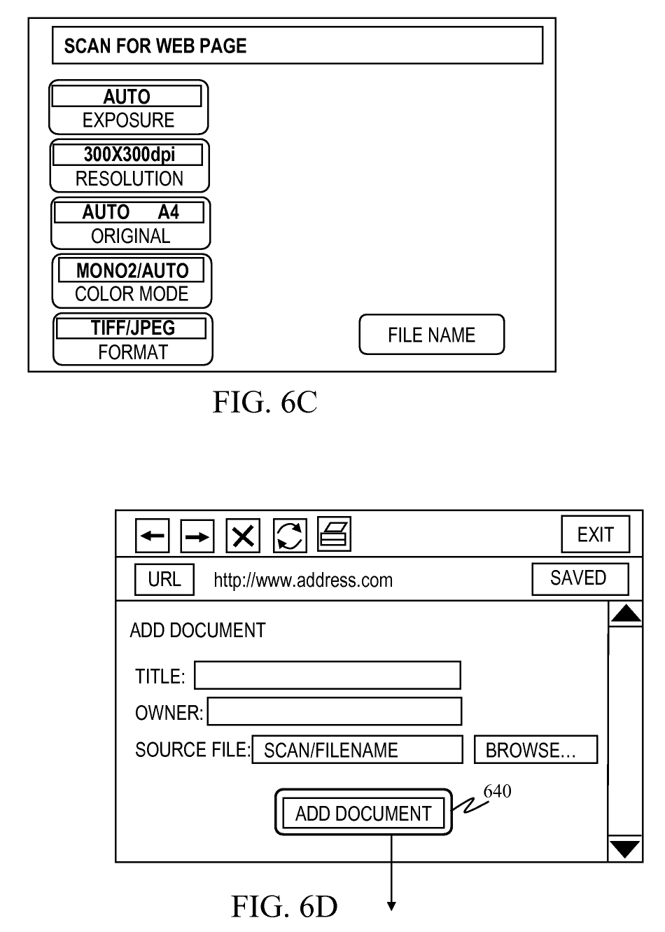

FIGS. 6A-6D show an example of a series user interface pages pertaining to the uploading of a file, according to embodiments of the present invention. The user views a page (FIG. 6A) having a form and a type=file input. This input is displayed as a text box with a browse button 630 next to it (FIG. 6B). When the user selects the browse button 630, the MFP prompts (FIG. 6C) the user to select scan settings and scan a document. The user presses the Start button and the MFP scans the file and stores it in a temporary location. Optionally, the MFP may provide a thumbnail preview of the scan by which the user may confirm the content. The user is then returned to the form page (FIG. 6D), and once the user presses the “add document” button 640, the MFP posts the scanned file to the server along with the other form data.

### E-Mail

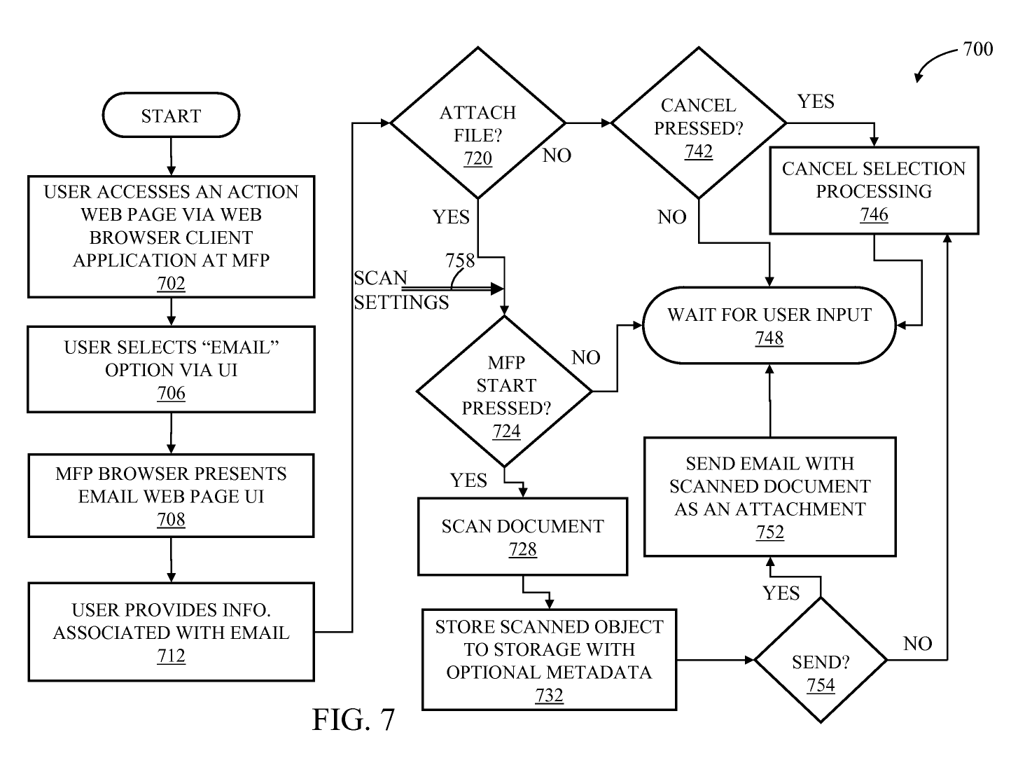

FIG. 7 illustrates in flowchart form an exemplary embodiment of the scanned e-mail process of the present invention. In this example, the user accesses and action web page via a web browser client application at the MFP (step 702). The user selects the “email” option via the user interface (step 706). The MFP browser presents an e-mail web page user interface (step 708). The user, at the next step (step 712), typically provides information to be associated with the email. The user is next queried (test 720) whether to attach a file. Scan settings 758 may be default or preset or may be updated by the user. If attaching a file is selected and if the start button of the MFP is pressed (test 724), then the document to be attached is scanned (step 728) and the resulting scanned object is stored with optional metadata (step 732). The user may then be queried (test 754) whether to send an email with the scanned document attached to the email (step 752) or the selection processing may be cancelled (step 746). If the process is cancelled (test 742) after the user declines to attach a file (test 720), then cancel selection processing is done (step 746) and the MFP is ready for user input (step 748).

So, in addition to content-type and type=file inputs, embodiments of the present invention provide a method for recognizing “mailto” in a URL. Below is sample HTML for a mailto link:
<a href=“mailto:address@company.com”>Displayed text</a>

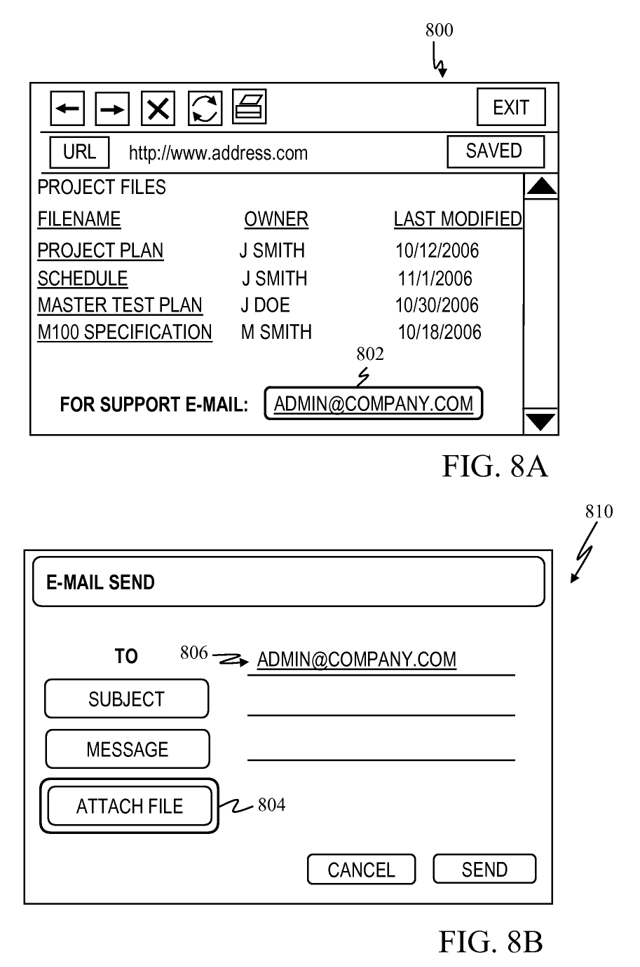

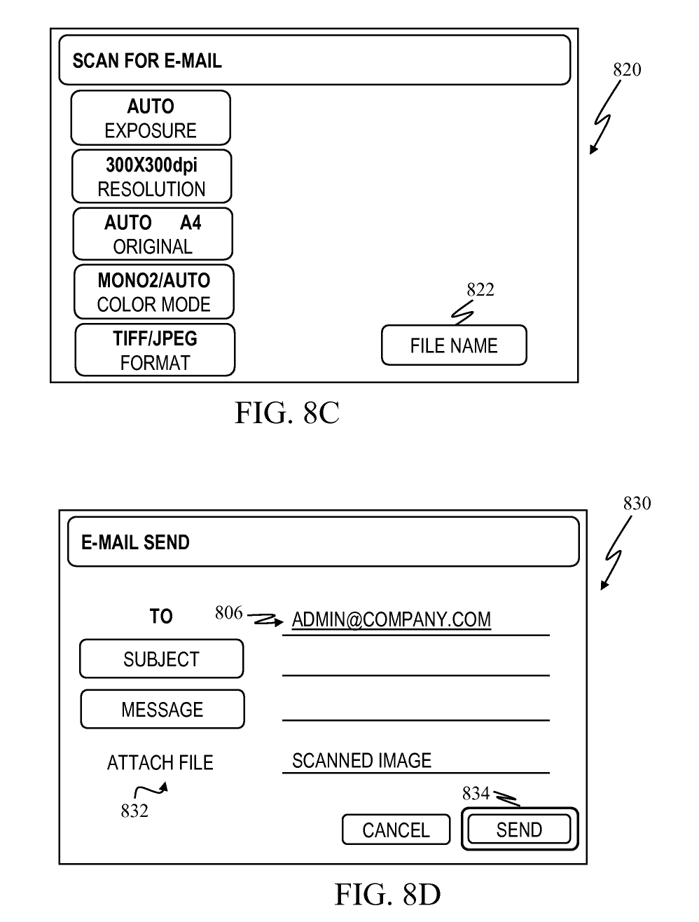

Embodiments of the present invention recognize the link and as shown as exemplary interfaces in FIGS. 8A-8D, prompt the user to enter e-mail fields and optionally attach a file. If the user elects to attach a file, the user may be prompted to select scan settings and scan a document. The user can then confirm the e-mail settings and send the mail. FIG. 8A shows an exemplary web page 800 of the MFP user interface where an e-mail hyperlink 802 is provided as admin@company.com and when clicked on, or otherwise selected, presents a second page 810 of dialog box as shown by example in FIG. 8B, where the address line 806 is automatically filled and the user may click or otherwise select the “ATTACH FILE” button 804. If the “ATTACH FILE” button 804 is selected, the user may be presented (FIG. 8C) with a web page or dialog box 820 of scanner settings and the option, via a “FILE NAME” button 822 to change settings and title the file that may result from the scanning of the document of interest. Once the document is scanned, the user may be presented (FIG. 8D) with a revised second page 830 or revised dialog box where, in addition to the address line 806, the “attach file” line 832 is filled with the file name indicating the named file is an attached object. Thereafter, the user may click or otherwise select the “SEND” button 834 to transmit the e-mail with the attached object.

In addition to the exemplary print, scan and e-mail functionality as illustrated in the forgoing embodiments, it contemplated that copying and FAXing functionality may be incorporated separately or collectively within the architecture of the several embodiments described herein. Embodiments of the present invention may be used in conjunction with networks, systems, and devices that may employ batch processing particularly via context menus. Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A multi-functional peripheral comprising:
an operation panel adapted to display at least one of: a print setting prompt, responsive to a print function tag; a scan setting prompt, responsive to a scan function tag; and an e-mail prompt, responsive to an e-mail function tag;
a browser adapted to drive a display of the operation panel and provide at least one of: the print function tag, the scan function tag and the e-mail function tag; and
at least one of:
(a) a printer adapted to print a file and responsive to a user input via the operation panel;
(b) a scanner adapted to scan a document and responsive to a user input via the operation panel; and
(c) an e-mail module adapted to transmit an e-mail field and an attached file and responsive to a user input via the operation panel.

2. The multi-functional peripheral of claim 1 wherein the operation panel is adapted to display: a print setting prompt, responsive to a print function tag; a scan setting prompt, responsive to a scan function tag; and an e-mail prompt, responsive to an e-mail function tag; and wherein the browser is adapted to drive the display of the operation panel and provide at least one of: the print function tag, the scan function tag and the e-mail function tag.

3. The multi-functional peripheral of claim 1 wherein the operation panel is adapted to display: a print setting prompt, responsive to a print function tag; a scan setting prompt, responsive to a scan function tag; and an e-mail prompt, responsive to an e-mail function tag; and wherein the browser is adapted to drive the display of the operation panel and provide: the print function tag, the scan function tag and the e-mail function tag.

4. A system comprising:
a server and a multi-functional peripheral operably connected to the server via a network link, wherein the multi-functional peripheral comprises:
an operation panel adapted to display at least one of: a print setting prompt, responsive to a print function tag; a scan setting prompt, responsive to a scan function tag; and an e-mail prompt, responsive to an e-mail function tag;
a browser adapted to drive a display of the operation panel and provide at least one of: the print function tag, the scan function tag and the e-mail function tag; and at least one of:
(a) a printing module, responsive to a user input via the operation panel, adapted to retrieve a file from the server and print the file;
(b) a scanning module, responsive to a user input via the operation panel, adapted to scan a document and generate a scanned document file and upload the scanned document file to the server; and
(c) an e-mail module, responsive to a user input via the operation panel, adapted to attach the scanned document file to an e-mail transmission via the server.

5. The system of claim 4 wherein the operation panel of the multi-functional peripheral is adapted to display: a print setting prompt, responsive to a print function tag; a scan setting prompt, responsive to a scan function tag; and an e-mail prompt, responsive to an e-mail function tag.

6. The system of claim 4 wherein the operation panel of the multi-functional peripheral is adapted to display: a print setting prompt, responsive to a print function tag; a scan setting prompt, responsive to a scan function tag; and an e-mail prompt, responsive to an e-mail function tag and the browser is adapted to provide: the print function tag, the scan function tag and the e-mail function tag.

7. A method of document processing comprising:
displaying, via an operation panel of an multi-functional peripheral (MFP) browser, at least one of: a print setting prompt when a print function tag is present; a scan setting prompt when a scan function tag is present; and an e-mail prompt when an e-mail function tag is present; and
responding as directed by a user input, via the operation panel of the MFP, by executing at least one subprocess selected from a group of subprocesses comprising:
(a) a file printing subprocess comprising: retrieving a file from a server and printing the retrieved file;
(b) a document scanning subprocess comprising: (i) scanning a document, (ii) generating a scanned document file and (iii) uploading the scanned document file to the server; and
(c) a document scanning and e-mailing subprocess comprising: (i) addressing an e-mail, (ii) scanning a document, (iii) generating a scanned document file and (iv) attaching the scanned document file to the e-mail; (v) uploading the scanned document file to the server and (vi) generating an e-mail transmission via the server, the e-mail transmission having the scanned document file attached to the e-mail transmission.

8. The method of document processing of claim 7 wherein the displaying step further comprises displaying, via an operation panel of an multi-functional peripheral (MFP) browser: a print setting prompt when a print function tag is present; a scan setting prompt when a scan function tag is present; and an e-mail prompt when an e-mail function tag is present;

9. The method of document processing of claim 8 wherein the responding step further comprises responding as directed by a user input, via the operation panel of the MFP, by executing:
(a) a file printing subprocess comprising: retrieving a file from a server and printing the retrieved file;
(b) a document scanning subprocess comprising: (i) scanning a document, (ii) generating a scanned document file and (iii) uploading the scanned document file to the server; and
(c) a document scanning and e-mailing subprocess comprising: (i) addressing an e-mail, (ii) scanning a document, (iii) generating a scanned document file and (iv) attaching the scanned document file to the e-mail; (v) uploading the scanned document file to the server and (vi) generating an e-mail transmission via the server, the e-mail transmission having the scanned document file attached to the e-mail transmission.
